(19) United States
(12) Patent Application Publication
(10) Pub. No.: US 2003/0234815 A1
(43) Pub. Date: Dec. 25, 2003

(54) Controlling a user interface

(76) Inventor: Paul J. Delaney, Galway (IE)

Correspondence Address: William M. Lee, Jr., Lee, Mann, Smith, McWilliams, Sweeney & Ohlson, P.O. Box 2786, Chicago, IL, 60690-2786, US

(21) Appl. No.: 10/177,008

(22) Filed: Jun. 21, 2002

(51) Int. Cl. G09G 5/00

(52) U.S. Cl. 345/762

(57) ABSTRACT

Typically, contact centre terminals have a user interface and in addition software to interpret messages from a server, maintain a state machine, and control the user interface appropriately. One problem with this type of arrangement is that a significant amount of software is required at each contact centre agent terminal besides the user interface. If any changes need to be made to the user interface control then software upgrades are needed at each terminal which is time consuming and expensive. These problems are addressed by enabling the user interface at each agent terminal to be effectively “driven” by the server remotely. The server is arranged to generate extensible Mark-up Language (XML) files (or other types of files) and send those to appropriate agent terminals. These XML files are used to control user interfaces at the agent terminals effectively “on the fly”.

### FIELD OF THE INVENTION

The present invention is concerned with control of user interfaces for communications systems. The invention is particularly related to but in no way limited to control of graphical user interfaces for multimedia contact centres.

### BACKGROUND TO THE INVENTION

Multimedia and other types of contact or call centre typically comprise a plurality of agent terminals all connected to a communications switch via a server. The communications switch links the contact centre to a communications network such as a public switched telephone network, data network or other network, and enables communications to and from the call centre. The server acts to route incoming contact messages to appropriate contact centre agents and routes messages from call centre agents back to the switch. Each contact centre terminal has a user interface and in addition software to interpret messages from the server, maintain a state machine, and control the user interface appropriately. The user interface may be of any suitable type, such as buttons and lights on a telephone handset or a graphical user interface on a computer.

One problem with this type of arrangement is that a significant amount of software is required at each contact centre agent terminal besides the user interface. If any changes need to be made to the user interface control then software upgrades are needed at each terminal which is time consuming and expensive. For example, this is required in order to support new messages or functionality.

This problem extends to other situations besides the contact centre example given above. That is, any situation in which a plurality of client machines have user interfaces that need to be controlled in response to communications or other status changes at a central server or other node to which the clients are connected.

The invention seeks to provide an improved method and apparatus for controlling a user interface.

An object of the present invention is to provide an improved method and apparatus which addresses or at least mitigates one or more of the problems noted above.

Further benefits and advantages of the invention will become apparent from a consideration of the following detailed description given with reference to the accompanying drawings, which specify and show preferred embodiments of the invention.

### SUMMARY OF THE INVENTION

According to the present invention there is provided a method of controlling a user interface at a client machine from a server with which the client machine is connected. The method comprising the steps of:

at the server, creating a message comprising information for updating a display at the user interface and sending that message to the client machine;

at the client machine, accessing a pre-defined structure of information;

at the client machine, updating the user interface on the basis of the accessed pre-defined structure of information and the message sent from the server.

This provides the advantage that at the client machine the software required to control the user interface is minimal. The user interface is effectively “driven” by the server which sends messages to the client machine, which can be for example, extensible markup language (XML) files and the pre-defined structure of information preferably comprises a stylesheet such as an extensible stylesheet language (XSL) stylesheet. Because the client machines are “thin” it is simple and cost-effective to implement changes in the user interface control software. This is done by making changes at the server only without needing to upgrade software at each client machine.

In a preferred situation the message comprises information about a communication. For example, the server and client machine are part of a contact centre which receives incoming communications from customers. Those communications are forwarded to an appropriate client machine and the user interface at that client machine updated appropriately using the method described above. For example, the server is arranged to create and send the message in response to an external contact arriving at the server which is part of a contact centre, or in response to a contact changing its state.

The client machine can be arranged to access the pre-defined structure of information from a web server which may be the server itself or a separate web-server accessible by the client machine.

The invention also encompasses a server for controlling a user interface at at least one client machine connected to the server, said server comprising:

a processor arranged to create an extensible mark-up language (XML) message comprising information to be displayed at the user interface; and

an output mechanism arranged to send the message to the client machine.

According to another aspect of the present invention there is provided a client machine arranged to be connected to a server in use, said client machine comprising:

a user interface;

a processor arranged to access one or more pre-defined structures of information;

an input arranged to receive XML documents from the server; and

a processor arranged to update the user interface on the basis of a received XML document and an accessed pre-defined structure of information.

The invention also encompasses a contact centre comprising a server and a plurality of client machines, as described above, each connected to the server.

According to another aspect of the present invention there is provided a method of operating a server in order to control a user interface at at least one client machine connected to the server, said method comprising:

creating an extensible mark-up language (XML) message comprising information to be displayed at the user interface; and

sending the message to the client machine.

According to another aspect of the present invention there is provided a method of operating a client machine which is connected to a server in use, said client machine having a user interface and wherein said method comprises:

accessing one or more pre-defined structures of information;

receiving XML documents from the server; and

updating the user interface on the basis of a received XML document and an accessed pre-defined structure of information.

The invention also encompasses a computer program arranged to carry out any of the methods described above. The computer program can be implemented in any suitable programming language as is known to the skilled person.

### BRIEF DESCRIPTION OF THE DRAWINGS

In order to show how the invention may be carried into effect, embodiments of the invention are now described below by way of example only and with reference to the accompanying figures in which:

FIG. 1 is a schematic diagram of a contact centre arrangement of the prior art;

FIG. 2 is a schematic diagram of a contact centre arrangement suitable for use in the present invention;

FIG. 3 is an example of an extensible mark-up language (XML) file for use in the present invention;

FIG. 4 is a flow diagram of a method according to the present invention carried out at the server in response to an incoming message from the switch;

FIG. 5 is a flow diagram of a method according to the present invention carried out at a client machine in response to an XML file being received from the server.

### DETAILED DESCRIPTION OF INVENTION

Embodiments of the present invention are described below by way of example only. These examples represent the best ways of putting the invention into practice that are currently known to the Applicant although they are not the only ways in which this could be achieved.

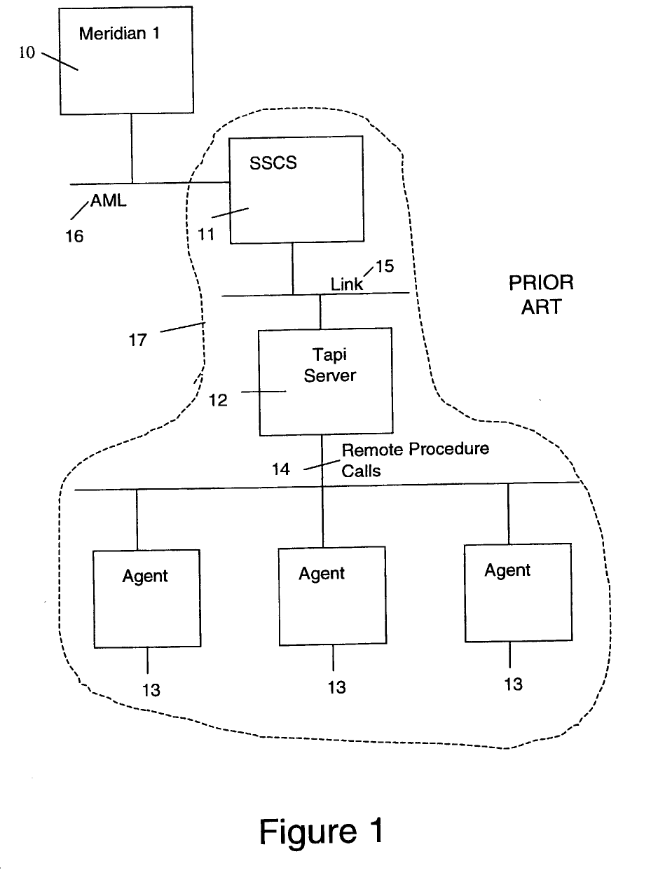

FIG. 1 shows a particular prior art situation in which a call centre 17 is connected to a communications network such as the public switched telephone network via a switch 10 such as a Meridian 1 switch as commercially available from Nortel Networks. (Meridian and Nortel Networks are trademarks.) The call centre comprises a plurality of call centre agent terminals 13 which are for example, personal computers connected together on a network and able to access a message router 12. The message router 12 in this example, is a telephone application programming interface (TAPI) as commercially available from Microsoft (trade mark) which acts to enable telephone messages (including telephone calls) to be provided to or from the agent terminals 13. The message router 12 communicates with the agent terminals 13 using a particular protocol such as the remote procedure calls protocol 14. Software for interpreting this protocol is provided at each of the agent terminals 13 and those terminals each also have a user interface and a state machine. The state machine acts as a record of the current status of the agent terminal with respect to calls. For example, the state machine for a particular agent terminal might indicate that an incoming call is in progress and has been so for a specified time. Each state machine is continually updated by the associated agent terminal. The TAPI server 12 also maintains several corresponding state machines, one for each agent terminal 13.

The TAPI server 12 is connected to a contact centre server 11 via link software such as that commercially available from Nortel Networks 15 and in this example, the contact centre server is Symposium Contact Center Server (SCCS) as commercially available from Nortel Networks. (Symposium is a trademark.) The contact centre server 11 has access to information about the availability and skill sets of agents working at the particular agent terminals 13 and is able to route incoming contacts to appropriate agent terminals 13.

In this situation, each agent terminal 13 needs to have the remote procedure call protocol enabled. In this way, call messages and events are communicated from the TAPI server to agent terminals 13 and the agent terminal is able to update a display on its user interface accordingly. For example, the agent terminal has a user interface which indicates when a new call request is pending.

If it is required to update the system in order that new functionality can be provided or new message types can be dealt with, it is necessary to upgrade the remote procedure call protocol at each of the agent terminals 13 as well as at the TAPI server 12. In addition, the agent terminals themselves must have appropriate hardware capability to enable the remote procedure call protocol software to be executed in addition to the software required for the other functions of the agent terminals, such as the user interface, state machine, and other software required for the agent's work.

The present invention enables these problems to be addressed and for the agent terminals to be as “thin” as possible. This is achieved by enabling the user interface at each agent terminal to be effectively “driven” by the TAPI server 12 remotely. The TAPI or other server is arranged to generate extensible Mark-up Language (XML) files (or other types of files) and send those to appropriate agent terminals 13. These XML files are used to control user interfaces at the agent terminals effectively “on the fly”. XML is a standard as defined by the World Wide Web consortium (W3C). The XML files comprise information about what changes to make to the user interface, for example, which buttons to light up, and this information is used at the agent terminal, together with pre-specified structures such as stylesheets, to update the user interface as appropriate.

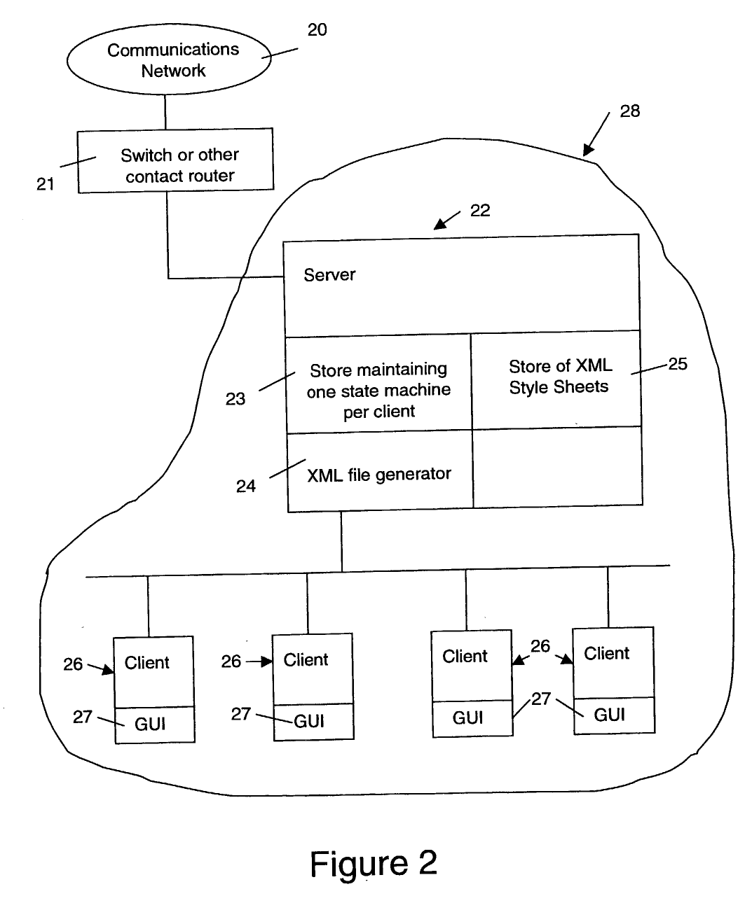

This is now described in more detail with reference to FIGS. 2 to 5. FIG. 2 is similar to FIG. 1 but with modifications in order to enable the present invention to operate. A contact centre 28 is connected to a communications network 20 via a switch or other contact router 21. The switch can be a Meridian 1 as in FIG. 1 or can be any suitable type of node for communicating contacts between the contact centre 28 and communications network 20. The contacts may be of any suitable media type such as email, telephone calls, video calls, sms, fax, EDI, Voice over IP and streaming. In this example, the switch and contact router functions are integrated into the same node 21 although this is not essential. The switch and contact router may be separate as in the example of FIG. 1.

The contact centre comprises a server 22 and a plurality of client machines 26. Each client machine comprises a graphical user interface (GUI) 27 or other type of user interface. For example, in a preferred embodiment the GUI is provided as a web browser which supports XML on the client machine. No state machines are provided on the client machines, unlike the prior art situation of FIG. 1. In addition, no protocol software such as remote procedure call protocol is provided on the client machines in contrast to the prior art situation of FIG. 1.

The client machine itself can be any suitable processor or communications device such as a WAP mobile telephone handset, a personal digital assistant (PDA), a laptop computer, or a desktop computer.

The server 22 may be a TAPI server as in FIG. 1 or any other suitable type of server for communicating contact messages and events between the client machines 26 and the switch or other contact router 21. As in the prior art situation the server 22 maintains a plurality of state machines, one for each client machine 26. This is indicated in FIG. 2 by store 23. In addition, and in contrast to the prior art situation, the server 22 comprises an XML file generator 24. It is not essential to use an XML file generator however, any system which generates information to be sent to client machines to indicate how the user interface at those client machines should be updated can be used.

In a preferred embodiment the server 22 is also able to act as a web server and has access to a store of XML stylesheets or other pre-specified information about how information from the server 22 is to be used to update the user interface at particular client machines 26. Alternatively, if the server 22 is not able to act as a web server, the client machines 26 are able to access a separate web server at which the XML stylesheets or other pre-specified information is stored. In a further embodiment, the stylesheets or other pre-specified information is stored at the client machines themselves.

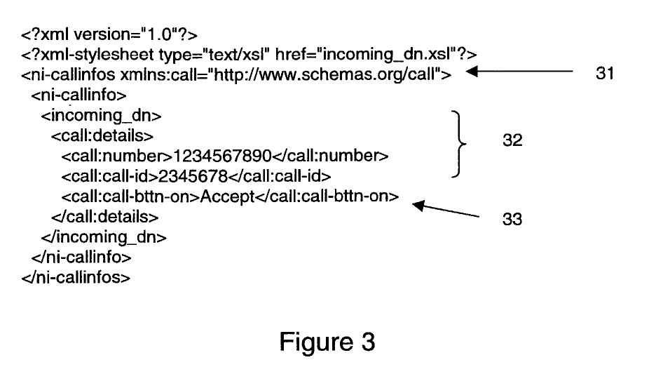

FIG. 3 shows an example of an XML file itself. The first part of this file 31 comprises details of two web addresses. At one of these locations the client machine receiving the XML file will be able to access an appropriate stylesheet for use with this XML file.

The next part 32 of the XML file explains that there is an incoming call and provides details of that incoming call comprising the directory number of the caller and an identifier for the call.

Part 33 of FIG. 3 contains instructions about updating the user interface at a client machine.

This is just one example of a simple XML file that can be used in the present invention. Other types of XML file can be used.

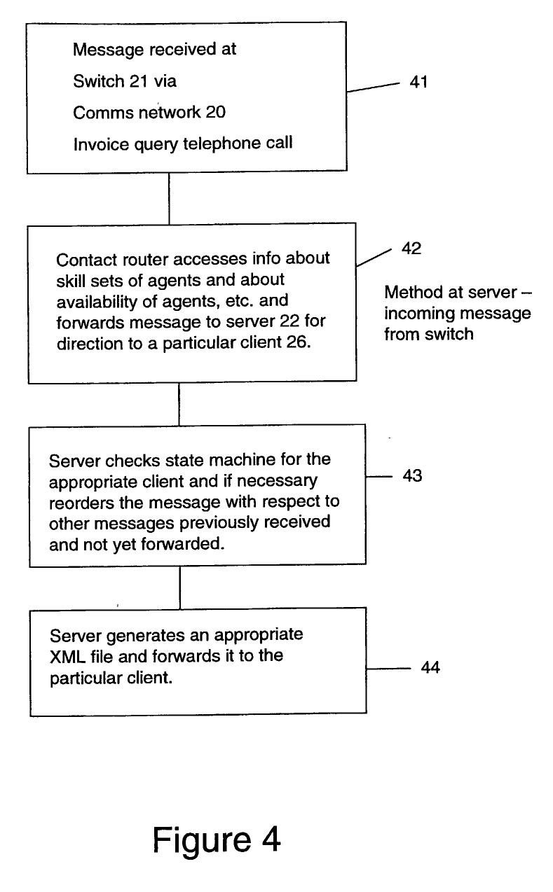

Consider now the situation in which a contact request arrives for processing by the contact centre 28. The method which occurs at the server 22 is described with reference to FIG. 4. A message is received at switch 21 via communications network 20 (see box 41 of FIG. 4). For example, this message could be a telephone call from a customer who wishes to make a query about an invoice.

The contact router then accesses information about skill sets (skill sets are areas of expertise, with different agents being members of different skill sets according to their knowledge and ability) of agents and about availability of agents. Using this information the contact router decides which client machine 26 to forward the incoming message to. The contact router then forwards the incoming message to server 22 for direction to the chosen client machine 26 (see box 42 of FIG. 4).

Next the server 22 checks its state machine for the chosen client machine and if necessary re-orders the message with respect to other messages previously received and not yet forwarded (see box 43 of FIG. 4).

The server 22 then generates an appropriate XML file and forwards this to the particular client machine 26. The XML file comprises information about the incoming call.

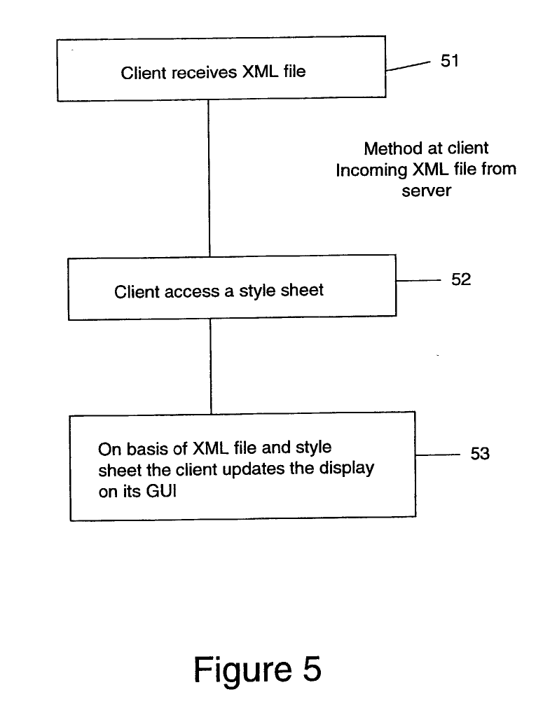

The ensuing steps which occur at the client machine are now described with reference to FIG. 5. The client machine receives the XML file from the server 22 (see box 51 of FIG. 5). The client machine then accesses a stylesheet or other pre-specified information about how to interpret the XML file (see box 52). For example, this pre-specified information can be stored at the client machine itself. However, in a preferred embodiment the client machine accesses the pre-specified information from a web-server which may be the server 22 within the call centre itself (or may be separate to the call centre). Preferably, the XML file comprises an address of the location at which the pre-specified information can be accessed This can be a web address as in the example of FIG. 3. In that case, the web browser on the client machine is activated to access the stylesheet or other pre-specified information from the web-address given. The stylesheet is preferably formed using extensible style language (XSL) as defined by W3C.

On the basis of the XML file and the stylesheet the client machine then updates the display on its graphical user interface (see box 53 of FIG. 5). For example, the information in the XML file is converted into hyper-text mark-up language (HTML) or any other mark-up language supported by the client machine. The web-browser of the client machine is then used to display information to the contact centre agent about the incoming call. An advantage of using stylesheets or an equivalent in this way is that is it a simple matter to add new stylesheets to support new types of display if required.

Thus far we have described incoming messages and events from the communications network to the contact centre and client machines. Any suitable method can be used for communications in the opposite direction, from the client machines to the communications network. For example, one option is for a client machine to send XML files to the server 22. In one embodiment this is achieved by enabling client machines to initiate HTTP POST commands with appropriate variables and send those commands to a web server. This web server is arranged to generate the required XML file on the basis of the variables and forward that to the server 22.

In another embodiment the client machine is arranged to initiate an HTTP SOAP request to an XML generator located on the network. The XML generator produced the required XML file and forwards that to the server 22.

1. A method of controlling a user interface at a client machine from a server with which the client machine is connected, said method comprising the steps of:
(i) at the server, creating a message comprising information for updating a display at the user interface and sending that message to the client machine;
(ii) at the client machine, accessing a pre-defined structure of information;
(iii) at the client machine, updating the user interface on the basis of the accessed pre-defined structure of information and the message sent from the server.

2. A method as claimed in claim 1 wherein said message comprises an extensible mark-up language (XML) file.

3. A method as claimed in claim 1 wherein said pre-defined structure of information comprises a stylesheet.

4. A method as claimed in claim 1 wherein said message comprises information about a communication.

5. A method as claimed in claim 1 wherein the client machine is arranged to access the pre-defined structure of information from a web server selected from the server itself and a separate web-server accessible by the client machine.

6. A server for controlling a user interface at at least one client machine connected to the server, said server comprising:
(i) a processor arranged to create an extensible mark-up language (XML) message comprising information to be displayed at the user interface;
(ii) an output arranged to send the message to the client machine.

7. A server as claimed in claim 6 which is arranged for use in a contact centre and wherein said server receives information about communications to the contact centre and creates the XML message on the basis of that received information about communications.

8. A client machine arranged to be connected to a server in use, said client machine comprising:
(i) a user interface;
(ii) a processor arranged to access one or more pre-defined structures of information;
(iii) an input arranged to receive XML documents from the server;
(iv) a processor arranged to update the user interface on the basis of a received XML document and an accessed pre-defined structure of information.

9. A client machine as claimed in claim 8 wherein said pre-defined structures of information are stylesheets.

10. A client machine as claimed in claim 8 wherein said pre-defined structures of information are accessed from a location specified in an XML document received from the server.

11. A contact centre comprising a server and a plurality of client machines, as claimed in claim 8, each connected to the server.

12. A method of operating a server in order to control a user interface at at least one client machine connected to the server, said method comprising:
(i) creating an extensible mark-up language (XML) message comprising information to be displayed at the user interface;
and
(ii) sending the message to the client machine.

13. A method of operating a client machine which is connected to a server in use, said client machine having a user interface and wherein said method comprises:
(i) accessing one or more pre-defined structures of information;
(ii) receiving XML documents from the server; and
(iii) updating the user interface on the basis of a received XML document and an accessed pre-defined structure of information.

14. A computer program arranged to carry out the method of claim 12.

15. A computer program arranged to carry out the method of claim 13.
